(19) United States
(12) Patent Application Publication
(10) Pub. No.: US 2003/0086605 A1
(43) Pub. Date: May 8, 2003

(54) Compression method for aviation weather products

(76) Inventor: John R. Doner, Melbourne, FL (US)

Correspondence Address: John L. DeAngelis, Jr., Esq., Beusse Brownlee Bowdoin & Wolter, P.A., 390 N. Orange Ave., Suite 2500, Orlando, FL, 32801, US

(21) Appl. No.: 10/007,333

(22) Filed: Nov. 8, 2001

(51) Int. Cl. G06K 9/00

(52) U.S. Cl. 382/166

(57) ABSTRACT

An imagery compression algorithm is disclosed for transmitting imagery data to an aircraft over a relatively narrow bandwidth channel. The imagery data is first trimmed to include only images required by the aircraft during flight. The image is also de-cluttered by removing geographical boundary lines and isolated pixels that likely do not represent relevant weather imagery data. The compression scheme provides a plurality of instructions for compressing the image data. The first instruction depicts the number of multiple image lines that contain no imagery data, i.e., they indicate only the background display color. Two instructions identify short background color segments and long background segments, wherein the division between short and long segments is a predetermined value. Each of the data or color pixels is individually encoded with a fourth instructions characterizing the number of successive data pixels followed by a bit sequence indicating the color of each individual data pixel.

### FIELD OF THE INVENTION

This invention relates generally to aircraft weather information systems and specifically to a data compression method for providing weather radar image date to an aircraft cockpit.

### BACKGROUND OF THE INVENTION

For obvious safety and comfort reasons, pilots require timely and accurate weather data to make informed decisions during both the pre-flight planning process and flight. For flight planning purposes, the pilot needs to know current weather conditions at the departure location and forecast weather conditions for the intended route of flight and the planned destination. Once enroute, the pilot should maintain a real-time awareness of actual and forecast weather conditions for the remaining flight route and also the intended destination and alternative destinations.

The present National Airspace System (NAS) weather support system provides extensive weather data for pre-flight planning and limited weather information during flight. This weather data is typically received verbally, during a pre-flight weather briefing. Through in-person weather briefings weather maps and charts of current and forecast weather conditions are available. Also, weather satellite images and copies of weather radar displays can be provided to the pilot during the briefing. Communications with air traffic controllers during flight offers an opportunity for the pilot to collect up to date weather information, although the information is provided verbally and based on interpretation of weather information by the controllers. En route alpha-numeric messages are provided to describe generally the weather enroute and at the intended destination, but is available only to airlines and transports equipped with ACARS receiving systems.

Commercial aircraft generally also employ an onboard weather radar system to determine weather conditions during the enroute flight path. Such weather radar systems are expensive, complex and require the availability of certain structural elements on the aircraft. For instance, a weather radar system requires the installation of a relatively large antenna and consumes a fair amount of aircraft power for the radar transmitter. The weather radar systems provides a view of oncoming weather over a range of approximately 150 miles. The pilot can thus plan his enroute path to avoid a storm front detected by the weather radar in the aircraft's current flight path.

The availability of en route weather information is also critical to the general aviation pilot. It is known that, for instance, in a four hour general aviation flight over a 500 mile route with thunderstorms forecast at about the halfway point, the National Airspace System weather support system would produce almost 2000 individual weather observations and forecasts that could be used to assimilate a detailed weather information picture during flight. It is obviously impractical for the pilot to request, receive and assimilate this amount of data directly. Therefore, the conventional practice is for the pilot to concentrate on the weather at the destination (and alternate destinations) during pre-flight planning, while enroute weather information is provided ad hoc from on-board observations by the pilot or by way of audio conversations with air traffic controllers during which generalized comments on the weather conditions are provided. General aviation aircraft are not typically equipped with a weather radar system.

Thus, general aviation pilots have difficulty obtaining pertinent and timely in-flight weather information to allow them to accurately detect weather trends along the flight route and thereby avoid the inclement weather. As an example, assume the pilot is given weather information and weather maps at the airport prior to departure, for example from New York City, and also weather information along the route and at the intended destination, for example, Los Angeles. During the flight of several hours the weather along the flight route and at the intended destination could change adversely. The pilot may learn of these weather changes enroute from disjointed information sources, such as air traffic controller conversations, but the information is typically incomplete and may lack the required accuracy.

Weather information can also be periodically collected and provided through a satellite communications system. See for instance U.S. Pat. No. 6,014,606. Weather information is collected from throughout a global region, periodically assimilated and compiled at a central source, sent via high speed data link to a satellite communications service, uplinked to the satellite, and then transmitted to an aircraft in flight. Again, such systems are generally too expensive for general aviation aircraft and further require the installation of specialized satellite receivers and antennas on the aircraft.

Although existing systems provide data and voice communications between the cockpit and ground, none are aptly suitable for conveying detailed weather data, especially weather radar imagery data. Since the radar imagery is very time-perishable (the typical refresh rate at each radar sites is six minutes), it must be delivered to the cockpit frequently and expeditiously. Generally, the radar image comprises a graphical display of the continental United States, including state boundaries, and pixels of a plurality of colors, where each color denotes precipitation intensity. The total data per image of the United States is approximately 1.7 Mbytes, requiring almost 20 minutes to transmit at an exemplary frequency of 11,760 bps. Even if the weather information update frequency is increased from about every 6 minutes to about every 10 to 12 minutes, which approaches the timeliness limit for usable weather information, the bandwidth/data rate demand for the weather products exceeds, by many times, the slower data rate bandwidths currently available for ground to air communications. Although higher-data rate communications may be available, the higher cost associated with these links may render the transmission of weather data to the cockpit prohibitive for certain users. Certain known data compression schemes can be applied to the weather radar images (also referred to as weather products). For instance, the ZIP data compression scheme, commonly employed for data transfer between computers, could be used to compress the weather data products. But this would require the addition of error detection and correction bits to the data stream and also add complexity to the receiving end components. Therefore, it remains to determine the optimum and cost effective weather product refresh rate, data compression scheme, link data rate, etc. for transmitting the data from a ground station to the cockpit.

### SUMMARY OF THE INVENTION

The present invention discloses a method and apparatus for communicating weather information to the aircraft cockpit using a form of data compression adapted to the various graphical depictions of weather phenomena, especially precipitation, which tends to be an accurate indicator of rough weather that the aircraft may encounter. The invention takes advantage of certain characteristics of the weather graphics data to reduce the quantity of data to be transmitted. The map on which the weather symbology is placed is invariant with time and thus the overlayed map is not transmitted. Instead, the map information resides permanently in the receiving equipment memory. In another embodiment, the map can be transmitted as the aircraft enters new airspace for which the applicable geographical map is not stored in memory. Also, information or locations that do not change from one graphics scene to another, such as the location of weather reporting stations, can be stored in memory at the receiving end to further reduce the required transmission bandwidth. The graphical image is then encoded as a single sequence of data bits, using four different data field types, also referred to as instructions. All the weather information derived by the pilot from the graphical image is based on the color of each individual image pixel. Two data field types of the compression scheme provide the pixel color information for long and short lines of pixels (each line being one pixel in width) where the line contains no weather data, i.e., all the pixels in the line are the background color. When interpreted by the display device, these data fields instruct the graphical display to display the background display color. A third data type encodes successive multiple lines of background color. The graphic weather information (in the form of color, i.e., non-background, pixels) is transmitted using the fourth date file types. Thus, by using a plurality of data field types, wherein each utilizes a different coding format to paint the graphical image, the number of data bits to be sent to the cockpit is reduced, thus allowing use of a relatively narrow bandwidth/low data rate signal to communicate the weather information from the ground to the cockpit, while providing the weather information on a timely basis for advantageous use by the aircraft pilot.

### BRIEF DESCRIPTION OF THE DRAWINGS

The foregoing and other features and advantages of the invention will be apparent from the following detailed description of the invention, as illustrated in the accompanying drawings, in which like numbered reference characters refer to the same parts throughout the different figures. The drawings are not necessarily to scale, emphasis instead being placed on illustrating the principals of the invention.

FIG. 1 is a block diagram illustrating a cockpit weather information system according to the present invention.

FIG. 2 is a software flowchart describing the imagery data compression scheme of the present invention.

### DETAILED DESCRIPTION OF THE INVENTION

Before describing in detail the particular cockpit weather information system according to the present invention, it should observed that the present invention resides primarily in a novel combination of processing steps and hardware related to a weather information delivery system. Accordingly, these processing steps and hardware components have been represented by conventional processes and elements in the drawings, showing only those specific details that are pertinent to the present invention so as not to obscure the disclosure with details that will be readily apparent to those skilled in the art having the benefit of the description herein.

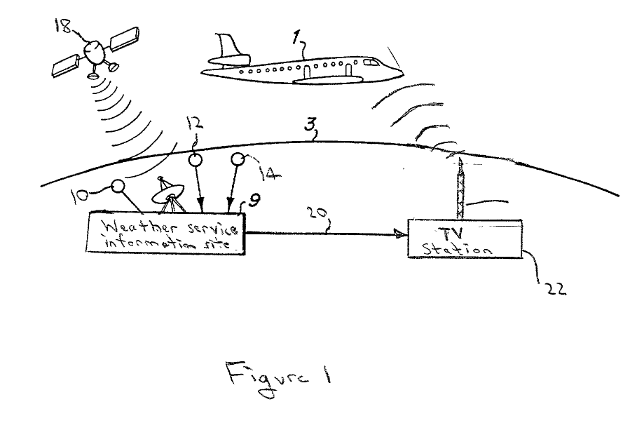

FIG. 1 is a block diagram illustration of a cockpit weather information system according to the present invention. An aircraft 1 is shown in flight over a global region 3. Typically, a global region covers a large geographic area such as the continental United States. In another embodiment of the present invention, the weather data collection and compression process can be carried out over a larger extended global region. Information describing the weather conditions within the global region 3 is periodically collected at a plurality of weather service information sites 9 from various weather information collection sources, identified by sensors 12, 14 and 16. These sensors can provide, for instance, temperature, pressure, humidity, wind direction, and precipitation information both on the ground and aloft. Weather information is also collected from a weather satellite 18. As is known, there are a large number of such weather service information sites across the continental United States and over other regions of the globe.

At the weather service information site 9, various weather products are created based on the sensor input data. An exemplary weather product is a map showing the regions of equal barometric pressure across the continental United States. As related to the present invention, another weather product of interest is weather radar imagery data showing precipitation intensity at various altitudes. This information can be determined from a radar return signal received at weather service information site 9. After the weather product based on the return radar images is created, it is transmitted via a communications link 20 to a television broadcasting station 22. From there, according to one embodiment of the present invention, the radar imagery data is transmitted, in compressed format, via a suitably constructed antenna to the aircraft 1. In one embodiment, the transmission occurs during the vertical blanking interval of the television signal transmitted by the television station 22 to local television receivers in the service area.

Use of the vertical blanking interval of existing television stations provides a convenient and readily available transmission source for sending the radar imagery data to the aircraft 1. The receiver (not shown) in the aircraft 1 is automatically tuned to an appropriate television station signal frequency within the area traversed by the aircraft 1. As the aircraft 1 moves out of the zone in which the television signal can be adequately received (for instance, when a metric such as the signal-to-noise ratio falls below a predetermined threshold) then the receiver automatically tunes to another television station signal frequency that provides an acceptable (i.e., above a predetermined received signal metric threshold) signal. The frequency to which the receiver is tuned is based on the aircraft location, which is in turn determined by the navigation and location information already available on the aircraft. As long as there is a television transmitting antenna that can provide an acceptable signal to the aircraft as it traverses its flight path, then weather imagery data continues to be available during the entire flight. Further, if the flight path segments lacking an acceptable received signal are relatively small and minimal in number, then the loss of radar weather image data as the aircraft traverses along that path will not present a significant problem.

Because the vertical blanking interval has a fixed and relatively narrow bandwidth, the radar imagery information is compressed so that the weather data can be transmitted to the aircraft 1 on a relatively frequent basis, to ensure it is timely available to the pilot for making en route flight decisions. In the preferred embodiment of the invention, delivery every 10 to 12 minutes is generally considered acceptable. It is especially important to provide timely weather information since weather systems can move rapidly into and out of the flight path. Although radar image data can be sent less frequently, this may not adequately serve the intended purpose and ensure that the pilot makes an early and accurate identification of problem weather areas so that the aircraft 1 can be routed along a different vector to avoid the area of disturbed weather.

Although the weather imagery data of interest as applied to the description of the present invention is specifically the precipitation intensity at various altitudes, other weather products (e.g., cloud cover, barometric pressure) can be compressed and broadcast according to the present invention. It must be recognized, however, that the more data that is broadcast to the aircraft, the longer the transmission time and therefore updates to the information may not be timely broadcast on a satisfactory schedule.

In particular, the algorithm according to the present invention for compressing the radar imagery data recognizes that the visual radar imagery data is superimposed over a map. Because the map boundaries and other fixed information (e.g., the location of weather service information sites or television station transmitting antennas) do not change with time, it is not necessary to transmit this information with the radar imagery data.

The radar imagery data comprises a plurality of pixels wherein the pixel color identifies a particular weather characteristic and each pixel represents a predetermined geographical area. Typically, such radar imagery data uses a limited number of colors, for instance, sixteen colors, where each pixel color represents a different precipitation intensity. Since precipitation occurs in localized areas, the weather data presented on the radar image usually occurs in small pixel clusters representing shower activity of varying intensity through out the cluster. Since rain showers seldom occur in isolation (e.g., as represented by only one or two adjacent pixels) such pixels are generally false radar return readings, representing, perhaps, a bird flock, a plane or another radar return anomaly. Also, these isolated color pixels are separated by large distances where there is no precipitation activity. The algorithm of the present invention identifies these isolated pixels and eliminates them from consideration. Thus the algorithm according to the present invention takes advantage of known weather characteristics to provide an efficient data encoding technique.

The compression algorithm of the present invention is not limited to weather radar imagery data, but can be utilized on any data that has image characteristics similar to those identified above. For example, radiology images or some false-color images of the earth, as obtained by a satellite imaging device, can be processed by the data compression algorithm according to the present invention.

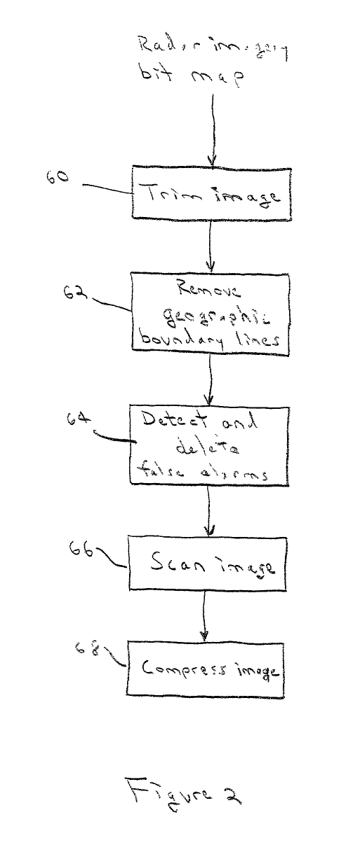

The data compression algorithm of the present invention is illustrated in the flowchart of FIG. 2. Generally, the compression process is implemented by examining successive individual pixel element characteristics through a microprocessor or specialized digital signal processor located at the weather service information site 9. Alternatively, the weather image data can be transmitted over the communications link 20 in uncompressed or raw form and then compressed at the television station 22 immediately prior to transmission over the vertical blanking interval of the television signal transmitted therefrom.

The compression algorithm according to the present invention begins by inputing radar imagery bit map data to a step 60 where the bit map file is trimmed to exclude any unnecessary territory for which the presented weather information is not pertinent to the aircraft pilot. For example, if the flight path takes the aircraft 1 over only the continental United States, then the image data over the Atlantic and Pacific Oceans and adjacent countries can be eliminated or cropped during the step 60. In another embodiment, the map can be further reduced in size to include, for example, the intended flight path and regions encompassing a predetermined number of miles on each side of the flight path. Generally, the bit map comprises color information for each pixel in the map, with each pixel color represented by a string of data bits, i.e., ones and zeros. The bit map is then simply a string of data bits. So long as the length and width of the map and the number of data bits representing a pixel color are known in advance, the string of data bits uniquely describes a display image.

Typically, the radar imagery bit map also includes geographic boundaries when the bit map is created at the weather service information service site 9. The boundaries are represented by a color different than the colors representing precipitation (or another weather information product). At a step 62, these boundary lines are eliminated. Specifically, this is accomplished by raster scanning the entire bit map in search of pixels having the color that represents a geographical boundary line. The color of these individual pixels is then changed to the background color so that the boundary lines are effectively eliminated. Of course, this step requires that the pixel colors used for the display of radar weather data cannot also be used as a boundary line color. Assuming that the background color for the radar image display is black, then according to the step 62 all the boundary line pixel colors are changed to black. Registration between the imagery data transmitted to the aircraft and the boundary map stored in the aircraft occurs without the use of special registration pixels because the map and the pixel bit map are the same size and shape.

At a step 64, so-called “false alarms” are detected and deleted. As discussed above, generally, these false alarms are isolated color pixels (i.e., non-background color) separated from other color pixels by a fixed minimum distance. For radar imagery data a pixel typically represents a square area four kilometers on each side. Radar imagery data, according to one embodiment of the present invention, must be separated by at least two pixels (approximately five miles) in every direction to deem the pixel a false alarm and remove it, i.e., by changing the pixel color to the background color. Other embodiments of the present invention can use a different fixed minimum distance to determine that a given pixel does not represent real weather data.

Now that the redundant and extraneous data has been removed, the actual data compression process begins at a step 66. This process is executed by assigning predetermined bit patterns (also referred to as instructions) to successive pixels in the image. In essence, each pixel is represented as one of a small set of colors, coded as efficiently as possible (i.e., using a minimum number of bits) as color codes. The process of assigning these color code bit patterns or instructions encodes and compresses the image bits so that fewer data bits must be sent over the data link, but still allowing recreation of the image at the receiving end. The radar image is scanned line by line and pixel by pixel (in one embodiment from the top left corner downwardly to the bottom right corner) and encoded using the instructions according to the present invention. Since these instructions are also known at the receiver, the image can later be recreated in the aircraft 1 by the reverse process.

According to the preferred embodiment of the present invention, there are four instructions for compressing the image at the source end. At the receiving end these instructions provide the necessary information to recreate the weather radar imagery data on a display screen within the aircraft 1. The first compression instruction relates to a plurality of consecutive multiple background color lines. In one embodiment, black represents the background color. There is no weather imagery data presented in the pixel line if it is composed entirely of black or background pixels. When N sequential black lines are found in the scanned image, terminating finally with a line N+1 that is not composed of all black pixels, (i.e., the N+1 line contains color data pixels representing weather information, such as precipitation), then one or more multiple black line instructions are generated by the compression process. The single multiple black line instruction is a single byte (8 bits) of the form:

00nnnnnn.

The first two bits (00) in the byte indicate a multiple black line instruction. The remaining 6 bits “nnnnnn” designate the number of consecutive black lines in the image, from 1 to 64 consecutive black lines. Thus all the pixels comprising from 1 to 64 black lines can be compressed into a single 8 bit word. For example, the byte, 00001101, defines thirteen successive black lines with no color (i.e., weather data pixels) in any of those lines.

For the case where there are more than 64 consecutive black lines, then N is the total number of consecutive black lines, Q is the largest factor of 64 in the total number of consecutive black lines and R is the number consecutive black lines less than 64, then for N>64,

N=64×Q+R, where 0≦R<64.

If R<64, then Q multiple black line instructions (of the form 00111111) will be transmitted, with each of the Q multiple black line instructions denoting sixty-four successive black lines. If R≠0, then the (Q+1)th multiple black instruction will indicate R black lines of pixels should be drawn following the Q groups of 64 black lines. For example, if there are 176=2×64+48 successive black lines, then Q=2 and R=48. To recreate the image, two instructions of the form 00111111 are formed (to draw the 128 consecutive black lines), followed by one instruction of the form 00110000 (to draw the 48 consecutive black lines).

When colored data pixels appear in one line of pixels, a different instruction is required. Because the weather event of interest typically covers a cluster of proximate pixels, there will generally be long strings of black pixels within each line. But typically, these segments of all-black pixels in line are too long to capture in a single data byte. Frequent short all-black segments also occur. Thus a short black segment instruction is used for pixel lines that contain both consecutive color pixels and strings of only black pixels. The short black segment instruction is a single byte of the form,

01nnnnnn.

The first two bits, 01, indicate that the instruction is a short black segment instruction. The following six bits indicate the number of consecutive black pixels in the line segment. Thus from 1 to 64 consecutive black pixels can be compressed into a single byte using this instruction.

The third instruction, a long black segment instruction, is similar to the short black segment instruction, but instead comprises 2 bytes of data to describe long black line segments exceeding 64 pixels in length. In this case the instruction begins with the bit 10, and is of the form

10nnnnnnnnnnnnnnnn

The 14 bits following the initial two instruction identifier bits indicate the number of pixels, from 1 to 2¹⁴ pixels, in the long black segment of the image.

The final instruction in the instruction set, referred to as the data set instruction, is denoted by initial bits “11” and describes all sequences of non-black (i.e., data or color) pixels. The first byte of this instruction, which does not have a fixed length like the previous instructions, has the form

11nnnnnn

The six nnnnnn bits indicate the number of non-black bits the color for which is set forth in the bits immediately following the first eight bits of the data set instruction. These six bits allow the color to be prescribed for from 1 to 64 consecutive color pixels. Bit-packed bytes representing the colors of the data pixels follow the eight bit instructional byte. For example, if four colors are used to display the imagery data, then the instruction byte denoted above is followed by a sequence of two-bit fields, since four colors can be represented by two bits. The number of two-bit color fields equals the number of consecutive color pixels (N), as set forth in the six bits of the data field. Each two-bit field represents the color for one of the N pixels, considered sequentially corresponding to a left to right scan across the pixel images.

For example, the data segment instruction below begins with the data segment instruction identifier 11. The value of the next six bits is seven, indicating that the color for each of the next seven bits follows the instruction, that is, this data segment instruction applies to the next seven consecutive pixels in the image.

11000111 11 10 10 10 10 01 01 11

Assuming that a 4 color radar image is supplied, then the data segment instruction byte is followed by seven two-bit fields, wherein each field represents the color of one of the seven pixels. In the example above, the first pixel is represented by color 11, the next four pixels are represented by color 10, the sixth pixel is represented by color 01 and the last pixel (the seventh pixel) is represented by the color 11. The spaces in the bits set forth above are merely for the reader's convenience; they do not appear in the bit stream. In general, if C colors are included in the weather radar image, then M bits are needed to uniquely identify the C colors, where 2^{M} is the smallest power of two greater than or equal to C.

If more than 64 consecutive bits are non-black, then multiple data segment instructions must be sent. This is similar to the transmission of multiple black line instructions if there are more than 64 successive black lines. It should also be noted that in the preferred embodiment, the data segment instruction does not cross multiple lines, i.e., it ends at the end of the line. If a consecutive sequence of non-black pixels extends from the right end of one line to the left beginning end of the next line, than two separate data segment instructions are generated according to the teachings of the present invention. While this technique of terminating a data set instruction at the end of a pixel line is preferable, it is not a required feature of the present invention.

One observation in conjunction with the teachings of the present invention recognizes that if one instruction is received at the aircraft 1 incorrectly, the consequences of this error will propagate throughout the remainder of the image, rendering the remainder of the image useless as color pixels will not be placed correctly in the image. Obviously, in an error-free transmission process, the above algorithm works perfectly. In one test of the compression algorithm conducted on a four kilometer square pixel (i.e., four kilometers on a side) of weather radar image for the entire continental United States, a compression ration of between 113 and 140 was achieved with no loss of data integrity. It is recognized, however, that all transmission channels are not perfect and introduce errors into the transmitted bit stream. If additional protection from these errors is desired, in one embodiment of the present invention a line designator data field can be placed at the end of the instruction that displays the last pixel on one or more lines. This line designator identifies the scan line to which the instruction pertains. The insertion of the line designator slightly reduces the total compression ratio of the algorithm, but also limits the effects of data transmission errors to single raster lines and in this way prevents the propagation of an error to other lines in the raster image. Adding, for example, a 11 bit line designator, (typically there are approximately 1000 lines in the image and therefore 11 bits can designate 211=2048 lines) adds about 600 bytes to a weather data file compressed according to the teachings of the present invention, reducing the compression ratio from about 113 to 140 to about 108 to 135. Thus the use of this error detecting information within the file does not seriously detract from its high compression ratio. In another embodiment, a line designator can be included at the beginning of each line, and in yet another embodiment line designators can be placed in the data stream at predetermined line intervals. Since the multiple black line instruction pertains to several display lines, a single line designator can be placed after the last image line of that instruction.

When the image is reconstructed in the aircraft, if the received line designator does not match the immediate previously displayed line, then the reconstruction device displays the next line of image pixels on the line identified by the received line designator plus one. Alternatively, the reconstruction device can check two or more consecutive line designators before determining that one or more incorrect lines have been displayed. Also, if sufficient storage capacity is available in or accessible by the reconstruction device, previous lines that were incorrectly displayed can be reconstructed and redisplayed using the stored data.

It is also possible to provide for data parity checking by replacing the two-bit designator for each of the four instructions with a 4-bit designator. This change provides a parity check on the transmitted data to a parity of modulo 16.

The compressed weather radar image is received at the aircraft via a suitable antenna and receiver tuned to the center frequency of a designated television signal broadcasting the compressed bit stream during the vertical blanking interval of the television picture. During flight, the receiver is preferably automatically retuned to the designated television station signal in the area of flight. Preferably, a amplitude modulation is employed to modulate the television signal with the compressed data bits during the vertical blanking interval. In one embodiment, a network of television stations are employed to broadcast the compressed radar image data, simplifying the transmission of the data to each station, since this can be accomplished via the existing network transmission facilities. Depending on the extent of the area served by the network, it may be possible in one embodiment, to limit the geographical area covered by the image to only the total broadcast area served by the television stations in the network.

The reconstruction device includes preferably a receiver for receiving and demodulating the received signal (in one embodiment transmitted during the vertical blanking interval of a television signal) to reproduce the data bit stream. A microprocessor, microcontroller or other processing device receives the bit stream and reconstructs the image by detecting the various data instructions and reading the appended data bits to assign the appropriate color to each image pixel, displaying the image on a integral or separate display for viewing by the aircraft pilot. Specifically, the instruction header (i.e., the first two bits of the instruction, 00, 01, 10 or 11) identifies the type of instruction to follow and the number of bits associated with that instruction. The next instruction header is found immediately following the number of bits required for the previous instruction. In one exemplary embodiment an iPAQ computer available from Compaq Computer Corporation of Houston, Tex., loaded with the decompressing software as described above, provides the data decompression function and the image is displayed on the integral iPAQ display. In another embodiment the decompressing device manipulates the image as the plane's heading changes, and further includes graphical user interface functionality, including in one embodiment, a touch screen selector capability.

While the invention has been described with reference to a preferred embodiment, it will be understood by those skilled in the art that various changes may be substituted for elements thereof without departing from the scope of the present invention. The scope of the present invention further includes any combination of the elements from various embodiments set forth herein. In addition, modifications may be made to adapt a particular situation to the teachings of the present invention without departing from its essential scope. Therefore, it is intended that the invention not be limited to the particular embodiments disclosed as the best mode contemplated for carrying out this invention, but that the invention will include all other constructions falling within the scope of the appended claims.

What is claimed is:

1. A method for compressing graphical image data comprising a plurality of pixels for display, wherein the pixels comprise background pixels for depicting the image background and data pixels having at least one different color than the background pixels for conveying information based on the data pixel color, said method comprising:
(a) scanning the pixels line by line;
(b) assigning a first instruction to a plurality of successive pixels depicting the image background, wherein the first instruction indicates the number of successive background pixels; and
(c) assigning a second instruction to a plurality of successive data pixels, wherein the second instruction indicates the number of successive data pixels.

2. The method of claim 1 wherein the step (b) further comprises:
(b1) determining the number of successive lines comprising only background pixels;
(b2) assigning a third instruction representing the number of successive lines determined at the step (b1);
(b3) determining the number of successive background pixels less than one line in length; and
(b4) assigning a fourth instruction representing the number of successive background pixels determined at the step (b3).

3. The method of claim 2 wherein the step (b3) comprises:
determining the number of background pixels between two data pixels in a single line of pixels;
assigning a fifth instruction if the number of successive background pixels is less than a predetermined value;
assigning a sixth instruction if the number of successive background pixels is greater than the predetermined value.

4. The method of claim 3 wherein the predetermined value is 64, and wherein the fifth instruction comprises an eight bit byte, and wherein the first and the second bits identify the instruction type and the third through the eighth bits identify the number of successive background pixels, and wherein the sixth instruction comprises two eight bit bytes, and wherein the first and the second bits identify the instruction type and the third through the sixteenth bits identify the number of successive background pixels.

5. The method of claim 1 wherein the step (c) further comprises:
(c1) determining the color of each successive data pixel; and
(c2) appending a plurality of bit fields to the second instruction, wherein each one of the plurality of bit fields identifies the color for one or more of the successive data pixels indicated by the second instruction.

6. The method of claim 5 wherein the number of bits in each one of the plurality of bit fields is determined by the number of colors to be displayed in the graphical image.

7. The method of claim 5 wherein the number of bit fields is equal to the number of successive data pixels indicated by the second instruction.

8. The method of claim 1 further comprising a preliminary step of reducing the graphical image size by deleting those pixels in one or more predetermined areas.

9. The method of claim 1 wherein the graphical image represents radar weather data.

10. The method of claim 9 wherein the radar weather data comprises precipitation data, and wherein the precipitation intensity is indicated by the color assigned to each data pixel.

11. The method of claim 1 wherein the step (c) further comprises determining the number of successive data pixels in each plurality of data pixels, and if the number is less than a predetermined number in one or more of the plurality of data pixels, changing the color of each data pixel in the one or more of the plurality of data pixels to the background color.

12. The method of claim 1 further comprising a step of assigning a line designator to one or more of the lines of pixels.

13. A method for forming a bit stream representing a compressed graphical weather image representing precipitation intensity over a geographical area, wherein the graphical weather image comprises a plurality of pixels for display, and wherein the plurality of pixels comprise background pixels all of a background color for depicting the image background and data pixels each having one of a plurality different colors, and wherein the data pixel color represents the precipitation intensity, said method comprising:
(a) deleting background and data pixels from predetermined areas of the image;
(b) scanning the pixels line by line;
(c) identifying data pixel segments within a line of pixels, wherein a data pixel segment comprises a plurality of successive data pixels, and wherein if there are less than a predetermined number of data pixels within the data pixel segment, changing the color of each data pixel within the data pixel segment to the background color;
(d) assigning a first instruction representing the number of successive lines composed entirely of background pixels;
(e) determining the number of successive background pixels in a line;
(f) assigning a second instruction representing the number of successive background pixels in a line;
(g) assigning a third instruction representing the number of successive data pixels in a line, wherein the third instruction comprises a first field representing the number successive data pixels and a second field representing the color of each successive data pixel; and
(h) concatenating the first, second and third instructions to form the bit stream.

14. The method of claim 13 wherein the graphical image weather data comprises geographical boundaries of a color different from both the background color and the data pixel colors, and further comprising the step of removing the geographical boundaries by changing the color representing the geographical boundaries to the background color.

15. The method of claim 13 wherein the step (f) further comprises:
determining whether the number of successive background pixels in a line is greater than a predetermined value;
assigning the second instruction to represent the number of background pixels in the line when the number of successive background pixels is less than the predetermined value; and
assigning a fourth instruction to represent the number of background pixels in the line when the number of successive background pixels is greater than the predetermined value.

16. The method of claim 13 further comprising the step of appending a line designator to the bit stream at the end of one or more pixel display lines.

17. A method of reconstructing a graphical weather image from a bit stream, wherein display parameters for a plurality of pixels are derived from the bit stream and drive a visual display, wherein the graphical weather image represents precipitation intensity over a geographical area, and wherein the graphical weather image comprises a plurality of pixels comprising background pixels of a background color for depicting the image background and data pixels each having one of a plurality different colors, and wherein the data pixel color represents the precipitation intensity, and wherein the said method comprises:
(a) identifying within the bit stream a first instruction representing the number of successive lines composed entirely of background pixels;
(b) producing a first number of pixels with a background display parameter, wherein the first number of pixels equals the number of pixels in the number of successive lines determined at the step (a);
(c) identifying within the bit stream a second instruction representing the number of successive background pixels in a display line;
(d) producing a second number of pixels with a background display parameter, wherein the second number of pixels equals the number of successive background pixels determined at the step (c);
(e) identifying a third instruction in the bit stream representing the number of successive data pixels in a line, wherein the third instruction comprises a first field representing the number of successive data pixels and a second field representing the color of each successive data pixel;
(f) producing a third number of pixels with a color display parameter, wherein the third number of pixels equals the value in the first field, and wherein the color display parameter for each one of the third number of pixels includes the color as set forth in the second field; and
(g) inputting the display parameters for the first, the second and the third number of pixels to the display for forming the visual image thereon.

18. A system for providing a graphical weather image to an aircraft, wherein the graphical weather image comprises a plurality of pixels, and wherein each one of the plurality of pixels further comprises a plurality of bits for controlling a display to display the graphical weather image, and wherein the graphical weather image comprises a background color and a plurality of information colors, wherein each one of the plurality of information colors denotes a precipitation intensity, said system comprising:
a data compressor for receiving data bits representing the pixels comprising the graphical weather image and for producing a compressed data bit stream by compressing the data bits according to the number of successive pixels of the background color and the number of successive pixels of the information color;
a carrier signal;
a modulator for modulating the carrier signal with the compressed bit stream;
a transmitter for transmitting the modulated carrier signal;
a receiver in the aircraft for receiving the modulated carrier signal;
a demodulator responsive to the received modulated carrier signal for recovering the compressed bit stream;
a data decompressor for decompressing the recovered compressed bit stream for producing the recovered data bits representing the pixels comprising the graphical weather image, by determining the number of successive pixels of the background color and the number of successive pixels of the information color; and
a display responsive to the recovered data bits for displaying the pixels comprising the graphical weather image.

19. The system of claim 18 wherein the transmitter is a television picture signal transmitter, and wherein the carrier signal is the carrier signal of the television picture, and wherein the television picture comprises an information interval during which picture information is transmitted and a vertical blanking interval during which no information is transmitted, and wherein the compressed data bit stream modulates the carrier signal during the vertical blanking interval.

20. The system of claim 18 wherein the display further comprises a stored image of the geographical boundaries of the graphical weather image, and wherein the geographical boundaries are displayed with the pixel display of the graphical weather image.
